(19) United States
(12) Patent Application Publication
(10) Pub. No.: US 2026/0197374 A1
(43) Pub. Date: Jul. 9, 2026

(54) ENABLING USER PRIVACY ON THIRD PARTY DEVICES

(71) Applicant: International Business Machines Corporation, Armonk, NY (US)

(72) Inventors: Joseph Kozhaya, Morrisville, NC (US); POORNIMA SRIDHAR, Bloomington, IN (US); Indran Naick, Cedar Park, TX (US)

(21) Appl. No.: 19/014,112

(22) Filed: Jan. 8, 2025

(51) Int. Cl. H04L 67/50; H04L 51/21

(52) U.S. Cl. CPC H04L 67/535; H04L 51/21

(57) ABSTRACT

Mechanisms are provided for detecting when recordings of activities or interactions may correspond to subsequent unsolicited or unwanted communications. A user computing device listens for a broadcast signal of a data collection device within a monitored environment. The user computing device determines, in response to receiving the broadcast signal, whether to allow or reject data collection by the data collection device. Moreover, in response to the user computing device determining to reject data collection by the data collection device, the user computing device sends a user signature of a user of the user computing device to the data collection device. The user computing device instructs the data collection device to not record data corresponding to the user signature when recording data associated with activities or interactions within the monitored environment.

### BACKGROUND

The present application relates generally to a data processing apparatus and method and more specifically to a computing tool and computing tool operations/functionality for enabling user privacy on third party devices.

Recording devices are prevalent in modern society with the proliferation of smart computing devices. For example, most individuals in western countries have a mobile phone device which includes microphones, cameras, and applications which capture data about how a user uses the mobile phone device. Moreover, smart assistant devices, such as Amazon Echo® (a registered trademark of Amazon Technologies, Inc.), Google Home® (a registered trademark of Google LLC), Apple HomePod® (a registered trademark of Apple, Inc.), and the like, are becoming more popular and further include such recording devices. Many times, these smart computing devices, in order to provide additional functionality and improve experiences for users, record occurrences in their environments, interactions with the devices themselves, and the like, so as to provide assistance to their users.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises listening, by a user computing device, for a broadcast signal of a data collection device within a monitored environment. The method further comprises determining, by the user computing device, in response to receiving the broadcast signal, whether to allow or reject data collection by the data collection device. Moreover, the method comprises, in response to the user computing device determining to reject data collection by the data collection device, sending, by the user computing device, a user signature of a user of the user computing device to the data collection device. In addition, the method comprises instructing, by the user computing device, the data collection device to not record data corresponding to the user signature when recording data associated with activities or interactions within the monitored environment.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of an artificial intelligence (AI)-based privacy preserving tool in accordance with one illustrative embodiment;

FIG. 3 is a flowchart outlining an example operation for active detection of recording and communicating user preferences in accepting or rejecting the recording in accordance with one illustrative embodiment;

FIG. 4 is a flowchart outlining an example operation for indirect detection of recording in environments in accordance with one illustrative embodiment; and

FIG. 5 is a flowchart outlining an example operation for indirect detection of recording in environments in accordance with another illustrative embodiment.

### DETAILED DESCRIPTION

The illustrative embodiments provide an improved computing tool and improved computing tool operations/functionality for enabling user privacy on third party devices. The illustrative embodiments provide an artificial intelligence (AI)-based privacy preserving tool that operates to monitor a computing device implementing the AI-based privacy preserving tool for instances of recording of user activities and interactions, e.g., voice input, video or image capturing, interactions with other applications of the computing device, and/or the like. The AI-based privacy preserving tool determines, based on user specified permissions, whether such recordings are permitted and if not, blocks the recordings or performs operations to remove aspects of the recordings that the user has stated are not permitted to be recorded, e.g., the user's voice, image, or the like. Moreover, the illustrative embodiments provide mechanisms to communicate such permissions to other second computing devices that are similarly configured with an AI-based privacy preserving tool, so as to cause these other second computing devices to block recordings of the user of the first computing device or remove such aspects of the recording not permitted by the user of the first computing device.

In some illustrative embodiments, the AI-based privacy preserving tool operates to correlate subsequent unsolicited content, e.g., advertisements, electronic mail messages, pop-up windows, or other communications, with interactions by the user and activities of the user that may have been recorded. These correlations may be used to notify the user as to the risk of being recorded when performing such activities or interactions subsequently. These correlations may be performed with regard to patterns of data representing an environment of the user as well, such that correlations between activities, interactions, and environments may be identified and further correlated with the subsequent unwanted communications or solicitations. Notifications of such correlations may be provided to the user and may be triggered in response to current detected conditions corresponding to these correlations. The notifications may present information about the user's activities, interactions, and/or environment, as well as the unsolicited content so as to inform the user of what triggers may be present and what unsolicited content may be triggered should the user engage in similar activity, interaction, or otherwise be present in a same or similar environment.

The illustrative embodiments have been designed to address problems in smart computing devices that implement various sensors and capture devices to capture data about users and their activities and interactions. That is, mobile computing devices, e.g., smart phones, smart assistant devices, such as Amazon Echo®, Google Home®, Apple HomePod® devices, and others have microphones, digital cameras, video capture devices, user interface monitoring applications, and the like, to collect data about the user's activities, interactions, and usage of the computing devices within environments of the computing devices. These data capturing devices are extremely pervasive and have capabilities to constantly record user activities and interactions with the computing device and their environments even without explicit consent by the user. Many times, this recorded information is used for providing subsequent communications to, and solicitations of, the user, such as via text messages, emails, audio outputs from smart computing devices, pop-up messages on computing device interfaces, and the like. While many times this is to make user experiences more beneficial to the user, sometimes these communications and solicitations are unwanted and the user would prefer to not have such recordings of their activities or interactions made in the first place, or not used for the purposes of subsequent communications/solicitations. Moreover, users often want to know when their information is being captured and used, even if they are accepting of such recording and usage.

For example, consider a situation where user A is communicating with user B, e.g., they are talking in User B's living room where user B has a smart computing device (e.g., an Amazon Echo® device) that is listening and collecting the data about the audio occurring within the room where the smart computing device is located. This collected data may be captured without user A's knowledge and without user A's explicit authorization or consent. Thereafter, user A and/or user B may be targeted with a subsequent communication or solicitation if the identity of user A's mobile computing device is known to the system. Even if user A's device is not known to the system, such unwanted solicitations or communications can be sent to user B, such as through the smart computing device, based on the collected data. This may be done without user A's consent and even without user B's consent to the recording of data for this specific conversation between user A and user B.

The above scenario illustrates the fact that with the proliferation of recording devices on computing devices, users often enter environments where they do not know that they are being recorded. That is, in the above scenario, even if user B has consented to recordings, this does not mean that user A has consented so such recordings. Thus, while the smart computing device may be validly recording user B during the interaction with user A, it may be invalidly recording user A as user A has not consented to such recordings.

Thus, there is a need for an improved computing device and improved computing device functionality that can detect when recordings are being performed and notify users when they are being recorded or are at a risk of being recorded. Moreover, there is a need for an improved computing device and improved computing device functionality for correlating unwanted communications or solicitations with prior activities, interactions, and environments where it is likely that recordings of a user were made that instigated the subsequent unwanted communications or solicitations. In this way, alerts or notifications may be presented to users to inform them of the risks of being recorded and the potential for subsequent unwanted communications or solicitations. The illustrative embodiments provide an AI-based privacy preserving tool that addresses these issues and provides such an improved computing device and improved computing device functionality.

With the mechanisms of the illustrative embodiments, an AI-based privacy preserving tool is provided that may be implemented on a computing device, which may be a mobile or stationary computing device. In some illustrative embodiments, these computing devices may be mobile smart phones having cameras, microphones, and the like, for recording data from an environment in which the mobile device is present. Moreover, these computing devices may be smart assistant computing devices, such as Amazon Echo®, Google Home®, Apple HomePod®, or the like, which are more stationary and monitor a given environment in which they are situated, often without having to be prompted to monitor and record audio/video data of the environment. These are only examples and other computing devices and their presence in environments may be utilized without departing from the spirit and scope of the present invention.

The AI-based privacy preserving tool implemented on the computing device provides a user interface through which the user can set preferences for explicitly opting out of recordings, particular types of recordings, allow recordings, allow only particular types of recordings, and the like. These preferences may even be specified with regard to locations of the user's computing device such that different permissions are applicable to different environments, e.g., when at work allow certain recordings, but when at home do not allow any recordings. The location or environment identification may be based on global positioning system (GPS) coordinates of a GPS of the computing device, mobile network location triangulation mechanisms, or the like.

Based on the user's preferences, and the environment, activities, and interactions being performed by the user in that environment, recordings are either enabled or disabled by the user's computing device via the AI-based privacy preserving tool. Moreover, when the computing device is present in an environment where there may be other computing devices recording the user, the AI-based privacy preserving tool on the user's computing device may communicate the user's preferences to other computing devices in the environment to cause them to comply with the user's recording preferences. In some cases, this may include sending, via an open protocol, to these other computing devices a voice signature, image, tracking signature, or the like, for the other computing devices to use to remove or strip out of recordings, recording data corresponding to the user. Thus, while these other computing devices may generate recordings of the activities and interactions occurring within an environment, these recordings will have the user's data removed or stripped out of the recording, obfuscated, or otherwise not accessible.

In some illustrative embodiments, further capabilities are provided by the AI-based privacy preserving tool in which artificial intelligence computer models operate to correlate embeddings of features of subsequent unwanted communications or solicitations with features of a previous activity, interaction, and/or environment in which the user's computing device has engaged. Thus, for example, if the user goes to an environment where there is another computing device, and a discussion of a particular theme is performed with another party, and later a communication is received by the user, where this communication has to do with the same theme, it may be determined that some unknown recording was performed at the environment which resulted in the subsequent unwanted communication. Such correlations may be made using vector representations or embeddings and vector similarity evaluations, by generating knowledge graph representations and evaluating the knowledge graph for relationships and patterns indicating a correlation between an activity, interaction, and/or environment and a subsequent communication or solicitation, or the like.

In response to such a correlation being identified, a notification may be presented to a user as to this correlation between activities, interactions, environments and subsequent unwanted communications or solicitations. The notification may indicate what activities and interactions are correlated with the unwanted communications or solicitations, what features of these are correlated, and if there is a correlation between environments and such communications/solicitations with the particular features correlated. In which way, the user is notified of the particular instances where recordings were made and used as a basis for unwanted communications or solicitations without the user's knowledge or express permission.

In addition, in some illustrative embodiments, a history of such correlations may be maintained by the AI-based privacy preserving tool and used to detect when the user is potentially engaging in activities, interactions, or approaching environments that may trigger similar recordings and unwanted communications/solicitations. For example, if a prior instance was detected where the user was recorded in a particular environment, e.g., a friend's home, and the user appears to be approaching this same environment, such as by monitoring GPS or other location determination mechanisms, then a notification may be output to the user via their computing device to inform them of the risk of being recorded and subsequent unwanted communications/solicitations.

Thus, the illustrative embodiments provide an improved computing tool and improved computing tool operations/functionality that operates to preserve a user's privacy with regard to recordings of their audio, images, and interactions with computing devices in accordance with user preferences. The illustrative embodiments provide capabilities to determine whether a recording of the user is likely being performed and to remove aspects of the user from recordings. The illustrative embodiments provide capabilities for one computing device to inform other computing devices of the user's preferences with regard to recordings and cause these other computing devices to abide by such preferences when performing recordings. The illustrative embodiments provide capabilities to correlate subsequent unwanted communications or solicitations with prior activities, interactions, and the like, to thereby determine a likelihood that these prior activities, interactions, and the like were recorded and using this information to provide notifications and alerts to users of the potential of recording occurring again in the future.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an AI-based privacy preserving tool and corresponding computing device and computing device functionality. The improved computing tool implements mechanism and functionality, such as an AI-based privacy preserving tool, which cannot be practically performed by human beings either outside of, or with the assistance of, a technical environment, such as a mental process or the like. The improved computing tool provides a practical application of the methodology at least in that the improved computing tool is able to control recordings by audio recording devices, video recording devices, or computing device interaction recording applications/devices, so as to preserve the privacy of users in accordance with user preferences and the environment in which these devices are present.

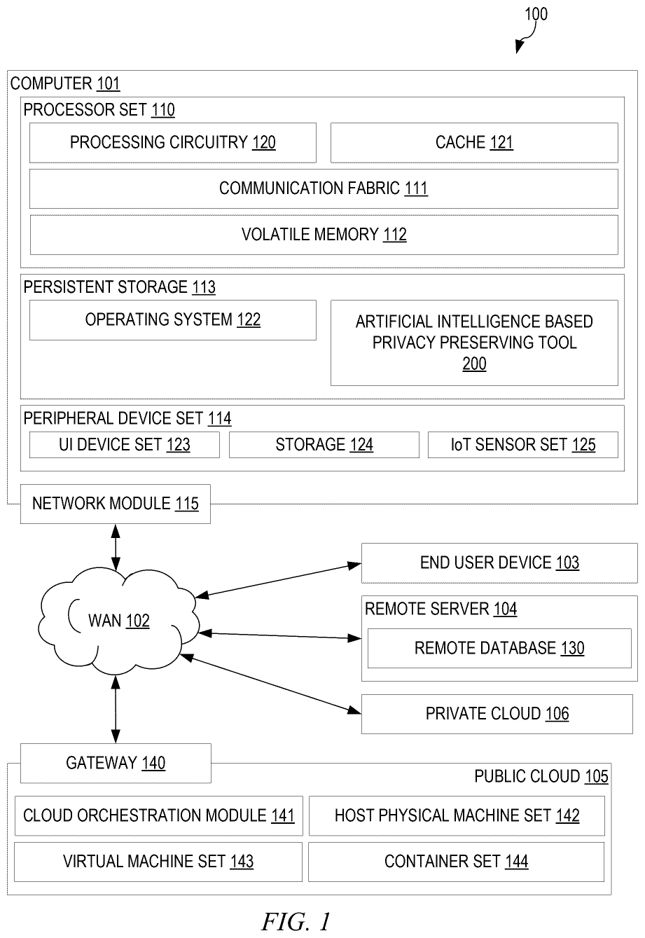

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as AI-based privacy preserving tool 200. In addition to AI-based privacy preserving tool 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and AI-based privacy preserving tool 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in AI-based privacy preserving tool 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in AI-based privacy preserving tool 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement an AI-based privacy preserving tool 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates preserving the privacy of individuals with regard to recordings by recording devices in environments as well as identifying correlations between activities and/or interactions and subsequent unwanted communications or solicitations which are indicative of those activities and/or interactions having been recorded.

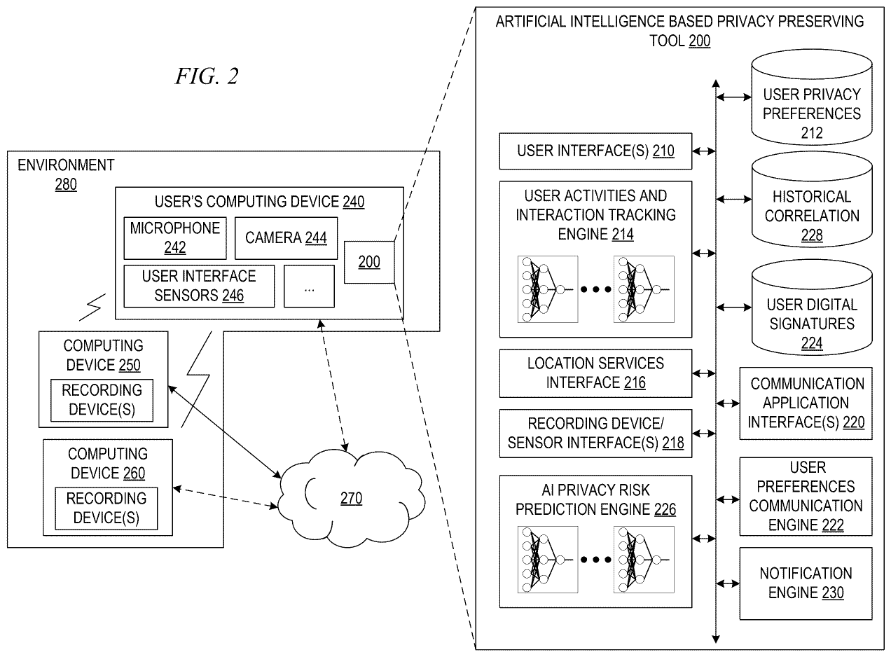

FIG. 2 is an example block diagram illustrating the primary operational components of an AI-based privacy preserving tool in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that privacy of individuals is preserved with regard to recordings by smart computing devices are performed, and providing a specific solution that implements artificial intelligence (AI) computing tools to correlate activities and interactions with subsequent unwanted communications or solicitations in order to determine a likelihood that the user was recorded, which cannot be practically performed by human beings as a mental process and is not directed to organizing any human activity.

As shown in FIG. 2, the AI based privacy preserving tool 200, or simply the PPT 200, comprises one or more user interfaces 210, a user privacy preferences storage 212, a user activities and interaction tracking engine 214, a location services interface 216, one or more recording device/sensor interfaces 218, one or more communication application interfaces 220, a user preferences communication engine 222, a user digital signature storage 224, AI privacy risk prediction engine 226, a historical correlation storage 228, and a notification engine 230. The PPT 200 may be implemented on a computing device 240, which may be a mobile or stationary computing device. In some illustrative embodiments, the computing device 240 may be a mobile smart phone or a stationary smart assistant device, for example. The computing device 240 may have one or more audio, image, application interaction, or other activity/interaction recording devices/sensors 242-246 with which the PPT 200 may operate. The computing device 240 may communicate with other computing devices 250-260 through wired and/or wireless communications either directly or through one or more wired/wireless data networks 270. These other computing devices 250-260 may similarly be either mobile or stationary computing devices and in some cases may have been configured with their own instances of the PPT 200.

The computing device 240 may be present in an environment 280 in which these other computing devices 250-260 may also be present. The environment 280 may be any physical environment which may be monitored for activity/interactions by a user. For example, recording devices may monitor the occurrence of audio within the environment 280, may monitor for movement or other indications of the presence of physical objects or users within the environment, or the like. The monitoring may be performed by one or more of the computing devices 240-260 using their recording devices/sensors, e.g., recording devices/sensors 242-246, such as microphone 242, camera 244, and other user interface sensors 246, which may capture recording data and store it for processing and later use, as well as communicate it to other parties.

The one or more user interfaces 210 provide mechanisms through which a user of the computing device 240 can set preferences for explicitly opting out of recordings, particular types of recordings, allow recordings, allow only particular types of recordings, and the like. These preferences may be specified with regard to locations of the user's computing device 240 such that different permissions are applicable to different environments. The user may designate the locations via any suitable mechanism, such as address, GPS coordinates, or the like. In some illustrative embodiments, when the user is in the particular location, the user can interaction with the user interfaces 210 to specify the identity of the current location and what privacy preferences are applicable at that location. Moreover, other configuration information for configuring the PPT 200 for the user's specific use may be made through these user interfaces 210, e.g., alert or notification preferences, font size, audio alert/notification preferences, risk prediction thresholds for triggering alerts/notifications, and the like. All of this configuration information may be stored in the user privacy preferences storage 212 for retrieval and use by the PPT 200 when monitoring the computing device 240 environment for recordings and/or for predicting the risk of the user being recorded by other computing devices in the same environment.

The user activities and interaction tracking engine 214 is responsible for obtaining data from location services and recording devices/sensors 242-246 to correlate activities/interactions detected by the recording devices/sensors 242-246 and the environment 280 in which the computing device 240 is present. That is, the user activities and interaction tracking engine 214, which may comprise one or more AI computer models trained to classify activities/interactions, receives the data from recording devices/sensors 242-246 and inputs this data into the one or more AI computer models to thereby classify the data as to a particular activity/interaction. This may include, for example, capturing audio data from a microphone 242, converting the audio data to a textual representation, and determining the themes or subject matter of the audio from a natural language processing and evaluation of the textual representation. Thus, if the user is having a conversation with another person regarding a particular product, e.g., shoes, the user activities and interaction tracking engine 214 may processing the audio data via the one or more AI computer models and determine that the theme is shoes and store this theme in association with temporal information for the activity/interaction and the location information for the environment. This is for later correlation with subsequent unwanted communications/solicitations. It should be noted that the actual recording itself and its specific content are not maintained in this instance and only the theme correlated with temporal and location information is maintained. This may be stored in the historical correlation storage 228.

The environment 280 in which the computing device 240 may be located may be determined using any suitable location service or location device, which may be communicated with via the location services interface 216. For example, the location services interface 216 may comprise the computer logic for communicating with a global positioning system (GPS), mobile network location triangulation mechanisms, or the like. Such communications and obtaining of location information is generally known in the art and thus, will not be described in greater detail herein. The location of the environment 280 is used for correlation with the detected activities/interactions, as noted above.

The one or more recording device/sensor interfaces 218 provide the computer logic for communicating with recording device/sensor applications through which recording data is captured using recording devices/sensors 242-246. These recording devices/sensors may be microphones, cameras, keyboard stroke detection, GUI interface monitoring and tracking software (e.g., tracks clicks and application selections), and the like. Any activities or interactions of a user that can be monitored by recording devices/sensors 242-246 may be the subject of the recording data captured by these recording devices/sensors 242-246 and processed/stored by their applications with which the recording device/sensor interfaces 218 may communicate.

The user preferences communication engine 222 provides the computer logic for communicating applicable user privacy preferences from the user privacy preferences storage 212 to other computing devices within the computing device 240 environment 280, e.g., other computing devices 250-260, so that they may enforce these privacy preferences on these other computing devices 250-260. The enforcement of such privacy preferences may take the form of disabling recording of the user of the user's computing device 240 within the environment 280 by these other computing devices 250-260, obfuscating, stripping out, or otherwise removing aspects of a recording specific to the user of the computing device 240, or the like.

In some cases, the user preferences communication engine 222 may send, in addition to the user's privacy preferences, one or more user digital signatures to these other computing devices 250-260 for them to use when obfuscating, stripping out, or otherwise removing data from recordings. For example, the user's digital signature may be a voiceprint, an image, or other data that can be used to identify a sub-portion of recorded data to be obfuscated, stripped out, or otherwise removed from a recording to thereby generate a modified or obfuscated recording in which the user's data is not present or is not uniquely identifiable of the user of computing device 240.

The historical correlation storage 228 stores correlations between identified activities/interactions, their themes, and locations/environments. This may be updated based on risk predictions generated by the AI privacy risk prediction engine 226 to include information about unwanted communications/solicitations that are received via one or more communication applications. In this way, the historical correlation storage 228 stores data structures that correlate activities/interactions, their themes, locations/environments, and unwanted communications/solicitations.

The AI privacy risk prediction engine 226 implements one or more AI computer models that operate to predict a risk that a historical activity/interaction was recorded and is the basis for a subsequently received unwanted communication/solicitation. The AI computer models evaluate features of an unwanted communication/solicitation received via a communication application, e.g., email, text, voicemail, or the like, to perform a theme analysis or subject matter classification, similar to the recordings of activities/interactions discussed above. In this way, themes in an unwanted communication/solicitation may be correlated with themes of activities/interactions stored in the historical correlation storage 228 may be performed. This may be limited to a particular time period prior to the receipt of the unwanted communication/solicitation, and thus, only records or data structures of the historical correlation storage 228 having temporal information within this time period may be considered. A degree of matching may be determined for the themes to thereby calculate a risk that a recording of the activity/interaction was made which is the basis of the unwanted communication/solicitation. If this degree of matching or calculation of risk is equal to or above a predetermined threshold, then a correlation between the activity/interaction, and the environment may be recorded in the historical correlation storage 228, or the entry/data structure updated to specify this correlation.

Thus, when an unwanted communication/solicitation is received via a communication application, a user may specify it as unwanted, such as by indicating it to be “junk” and moving it to a “junk” folder, or the like, and the AI privacy risk prediction engine 226 may then automatically operate to evaluate whether that communication/solicitation is correlated with a historically recorded activity/interaction. If there is a sufficient level of risk or matching, then it may be determined by the AI privacy risk prediction engine 226 that there is a correlation and thus, the historical activity/interaction was somehow recorded in the corresponding environment and the recording used to cause the unwanted communication/solicitation to be sent to the user. These records/data structures in the historical correlation storage 228 may be flagged or otherwise augmented to indicate that the environment is likely engaged in recording users and may be the source of unwanted communications/solicitations. In some embodiments, the features of the unwanted communications/solicitations may be stored in these records/data structures for use in generating notifications or alerts.

Based on such correlations, the AI privacy risk prediction engine 226 may also monitor the computing device 240 current location. The AI privacy risk prediction engine 226 may scan the records of the historical correlation storage 228 to determine environments that are within a given distance of the current location and determine if any of these environments have associated unwanted communications/solicitations indicated, e.g., the record/data structure is flagged or marked as having unwanted communications/solicitations and/or the features of these unwanted communications/solicitations are stored therein. For example, when the computing device 240 is approaching or has entered the environment 280, the location of the environment 280 may be checked against the historical correlation storage 228 records/data structures to determine if it is indicated to be a risk for recordings.

If an environment of this type is detected as being within the given distance, then an alert or notification may be generated by the notification engine 230. The content of the alert or notification may be generated based on the information stored in the record/data structure specifying the correlation between activities/interactions, the environment, and unwanted communications/solicitations. For example, a warning message may be output on the computing device 240 indicating that the environment 280 is a risk for recordings of audio and/or video and unwanted communications/solicitations regarding a particular theme. Thus, the user is informed of the risk and may make decisions as to whether or not to engage in activities/interactions in the environment 280, knowing that they will likely be recorded and used to send unwanted communications/solicitations.

With these mechanisms in place, based on the user's privacy preferences as specified via the one or more user interfaces 210 and stored in the user privacy preferences storage 212, and the environment 280, activities, and interactions being performed by the user in that environment 280, recordings are either enabled or disabled by the user's computing device 240 via the PPT 200. Moreover, when the computing device 240 is present in an environment 280 where there may be other computing devices 250-260 recording the user, the PPT 200 on the user's computing device 240 may communicate the user's privacy preferences, via the user preferences communication engine 222, to other computing devices 250-260 in the environment 280 to cause them to comply with the user's privacy preferences. In some cases, this may include sending, via an open protocol, to these other computing devices 250-260 a voice signature, image, tracking signature, or the like, as stored in the user digital signature storage 224, for the other computing devices 250-260 to use to remove or strip out of recordings, recording data corresponding to the user. Thus, while these other computing devices 250-260 may generate recordings of the activities and interactions occurring within an environment 280, these recordings will have the user's data removed or stripped out of the recording, obfuscated, or otherwise not accessible.

As noted above, the AI privacy risk prediction engine 226 of the PPT 200 operates to correlate embeddings of features of the unwanted communications or solicitations with features of a previous activity, interaction, and/or environment in which the user's computing device has engaged, such as may be stored in the records/data structures of the historical correlation storage 228. Thus, for example, if the user goes to an environment 280 where there is another computing device 250, and a discussion of a particular theme is performed with another party, and later a communication is received by the user, where this communication has to do with the same theme, it may be determined that some unknown recording was performed at the environment 280 which resulted in the subsequent unwanted communication. Such correlations may be made using vector representations or embeddings and vector similarity evaluations by the AI privacy risk prediction engine 226, by generating knowledge graph representations (not shown) and evaluating by the AI privacy risk prediction engine 226 the knowledge graph for relationships and patterns indicating a correlation between an activity, interaction, and/or environment and a subsequent communication or solicitation, or the like.

In response to such a correlation being identified, the notification engine 230 may generate and output a notification to a user on the computing device 240 as to this correlation between activities, interactions, environments and subsequent unwanted communications or solicitations. The notification may indicate what activities and interactions are correlated with the unwanted communications or solicitations, what features of these are correlated, and if there is a correlation between environments and such communications/solicitations with the particular features correlated. In this way, the user is notified of the particular instances where recordings were made and used as a basis for unwanted communications or solicitations without the user's knowledge or express permission. This may be done in response to the unwanted solicitation/communication having been received and designated by the user to be unwanted, e.g., “junk”.

As noted above, a history of such correlations may be maintained in the historical correlation storage 228 and used to detect when the user is potentially engaging in activities, interactions, or approaching environments that may trigger similar recordings and unwanted communications/solicitations. For example, if a prior instance was detected where the user was recorded in a particular environment, e.g., a friend's home, and the user appears to be approaching this same environment, such as by monitoring GPS or other location determination mechanisms via the location services interface 216, then the notification engine 230 may output a notification to the user via their computing device 240 to inform them of the risk of being recorded and subsequent unwanted communications/solicitations.

In one aspect of the illustrative embodiments, the PPT 200 can apply the user's privacy preferences as stored in the storage 212 to the particular recordings performed by the user's computing device 240. These user privacy preferences may be tied to specific locations or environments, in which case the PPT 200 will determine the current location, correlate it with locations or environments specified in the user privacy preferences storage 212, and apply the applicable privacy preferences to the operation of the recording devices/sensors 242-246 of the computing device 240. Thus, for example, if the user specifies that they do not want their image to be recorded when at a work location, then when recording activities/interactions of the user in a work location, the portions of the recordings involving the user's image may be obfuscated or removed from the recording data, or the camera 244 may be disabled while at the indicated location.

In addition to controlling the recording performed by the user's computing device 240 based on user privacy preferences, these user privacy preferences can be used to control the recordings made by other computing devices 250-260 in the environment 280. The following will provide examples of methodologies for such controlling of recordings by other computing devices 250-260 may be performed, but these are not intended to be limiting on the particular illustrative embodiments. Those of ordinary skill in the art will recognize other mechanisms for controlling the recordings performed by computing devices 250-260 which may include additional or alternative operations than those described herein. These alternatives are intended to be within the spirit and scope of the present invention.

In a first methodology for controlling recordings of other devices based on user privacy preferences, applications and voice/video enabled computing devices 250-260 notify the user computing device 240 that the user of the computing device 240 is being recorded, and vice versa. In this methodology, recording applications executing on computing devices 250-260 communicate with the PPT 200 on the user's computing device 240 to obtain the user's privacy preferences from the user privacy preferences storage 212. That is, the PPT 200 on the user's computing device 240 comprises computing logic to listen for broadcasts from other computing devices 250-260. These other computing devices 250-260 broadcast a message indicating that they are recording audio, video, or other activities/interactions within the environment 280. Based on the user's privacy preferences, the PPT 200 may accept, partially accept, or reject the recording of the user by these other computing devices 250-260. This may involve correlating the current location with locations specified in the user's privacy preferences and applying the privacy preferences determined to be applicable to the current environment 280. For example, the user may specify in their privacy preferences that audio recordings are always, never, or on a case-by-case basis as indicated by user input, permitted.

If recording is accepted, then normal recording operations are performed by these other computing devices 250-260. If the case-by-case basis is specified, the user may be prompted to respond with acceptance or rejection of the recordings via the one or more user interfaces 210. If rejection or partial acceptance of the recordings is indicated, then the user's privacy preferences may be transmitted along with a user's digital signature, e.g., voice signature, image, tracking signature, or the like, to the other computing devices 250-260 and the user's voice, image, or tracking data is stripped out of any recordings made by these other computing devices 250-260.

The above is an example of an explicit detection of recordings since the other computing devices 250-260 explicitly notify the user's computing device 240 that they are recording the user. However, such explicit notification may not always be performed and the user may still be subject to recordings in environments without the user's knowledge or permission. Thus, in a more implicit detection of recordings, rather than the explicit detection in the first methodology, two other example methodologies may be implemented. That is, in a second methodology, implicit detection of recording may be performed using vector databases and correlations. In a third methodology, knowledge graphs may be generated and used to perform correlations to implicitly detect environments in which recordings are being performed.

In the second methodology, the PPT 200 records user activities and interactions with the environment 280 and attempts to correlate activities and interactions and the environment 280 with unwanted communications or solicitations. The user activities and interaction tracking engine 214 tracks user activities and interactions throughout the day, things the user verbalizes, emails the user reads, calendars accessed and calendar entries access, and other activities/interactions. As the user performs these activities/interactions, the user activities and interaction tracking engine 214 may utilize one or more AI computer models to extract entities, intents, and locations to build “themes”, e.g., themes T1, T2, T3 . . . , etc.

The PPT 200 also tracks unsolicited or unwanted communications or solicitations received via one more communication applications, such as ads, emails, pop-ups, etc. Using a similar AI computer model analysis as above, the PPT 200 collects these unwanted and unsolicited communications/solicitations M1, M2, M3, etc. and determines the themes associated with these communications/solicitations. The PPT 200 correlates the themes built from the activities/interactions with the themes determined to be part of the received unwanted or unsolicited communications or solicitations.

To do this, a vector database (not shown) is built by the AI privacy risk prediction engine 226 and is populated by Machine learning with embeddings for known marketing/unsolicited communications/solicitations (e.g., marketing themes). The embeddings of the incoming communications/solicitations (M1, M2 . . . , etc.) are compared to the embeddings in the existing vector database or create new embeddings. The themes (T1, T2, T3, etc.) can be made to be “expire” after a period of time to avoid incorrect correlations with historical activities/interactions recorded in the historical correlation storage 228. A distance or vector similarity calculation can then be performed for the themes and messages and if the distance is below a threshold, this may trigger the generation of an alert or notification of the likelihood that a message was sent because of the historically recorded activity/interaction in the corresponding environment.

Subsequently, the PPT 200 may generate alerts or notifications when the computing device 240 is again in the same environment or is within a given distance of the same environment. The alert or notification may provide summaries of the activities and interactions as well as the unwanted or unsolicited communications or solicitations that were determined to be tied to these activities/interactions. In order to avoid incorrect alerts/notifications, a minimum number of instances of the same correlation may be required before generating these preemptive alerts/notifications.

In a third methodology, with regard to implicit detection of recordings, a similar approach to that of the second methodology is follows except that rather than relying on vector embeddings of features of the activities/interactions/environment and vector embeddings of subsequently received unwanted/unsolicited communications/solicitations, the third methodology relies on the generation of knowledge graphs having entities represented as nodes and relationships represented as edges.

As with the second methodology, the user activities and interaction tracking engine 214 tracks user activities/interactions throughout the day, things the user verbalizes, emails the user reads, calendars accessed and calendar entries access, and other activities/interactions. As the user performs these activities/interactions, the user activities and interaction tracking engine 214 may utilize one or more AI computer models to extract entities, intents, and locations to build “themes”, e.g., themes T1, T2, T3 . . . , etc. The PPT 200 also tracks unsolicited or unwanted communications/solicitations received via one more communication applications, such as ads, emails, pop-ups, etc. Using a similar AI computer model analysis as above, the PPT 200 collects these unwanted and unsolicited communications or solicitations (messages) M1, M2, M3, etc. and determines the themes associated with these communications/solicitations. The PPT 200 correlates the themes built from the activities/interactions with the themes determined to be part of the received unwanted/unsolicited communications/solicitations.

The extracted entities from the activity and interaction tracking and the unwanted/unsolicited communications/solicitations are used by the AI privacy risk prediction engine 226 as a basis for building a knowledge graph (not shown) of these entities. Relations between these entities are identified from the patterns of characteristics and contexts of the entities.

For example, when user interaction information is collected, a semantic model is used to extract entities, intents, and locations to build themes (T1, T2 . . . etc). For example, a user may be with a friend and may be talking about the user's new kitchen project and the user's ideas for cabinets. Through computer speech-to-text functionality and computer natural language processing, key terms/phrases associated with entities, intents, and locations may be extracted and correlated with themes, e.g., kitchen, renovation, cabinets, etc. These are stored in a vector data structure or graph database.

Incoming unsolicited communications are also tracked and, using the same computer logic and semantic model, message themes (M1, M2 . . . etc) are built. For example, the next day, the user may receive a pop-up ad on their browser for a kitchen cabinets store. These message themes are stored in a similar vector data structure or graph database.

The illustrative embodiments may then determine the distance between all the user themes (T1, T2 . . . etc) and the message themes (M1, M2 . . . etc). These distances are then used to determine correlations. For example, the user theme (Tx—Cabinet) would be close to the message theme (Mx—kitchen cabinet) obtained from the pop-up add from the kitchen cabinet store. False triggers can be avoided by requiring a minimum number of correlation triggers before a notification is sent. User themes and/or message themes can be made to expire after a period of time to avoid incorrect correlations with historical events.

The knowledge graph may then be used by the AI privacy risk prediction engine 226 when determining whether there is a risk of recording in a given environment. As mentioned above, the process of populating the knowledge graph involves leveraging AI models (Large Language Models or traditional Natural Language Processing models) to extract key entities and relationships from the natural language text that is collected based on the user's interactions (for example, things the user says as audio can be transcribed into text). These extracted entities form the nodes in the knowledge graph. Additionally, AI models may also extract relationships from text and these relationships form the edges in the knowledge graph. For example, if the user is talking about checking kitchen cabinets at “Kitchen Kabinets R Us”, then cabinets and “Kitchen Kabinets R Us” would be extracted entities and “checked at” would be the relationship edge connecting cabinets and “Kitchen Kabinets R Us”.

Similar to the other methodologies, alerts or notifications may be generated based on a comparison to the knowledge graph of the current situation of the computing device 240, such as when the computing device 240 is in, or is near, the same environment. The notifications or alerts may comprise content obtained from the knowledge graph representing the entities and relations that are the basis for the notification or alert.

For both knowledge graph and semantic matching using vector embeddings, the objective is to identify similarities between themes discussed by the user in a given environment and any messages the user gets at a later point in time. The main difference between the two approaches is that with semantic vector embeddings, the comparison may be done against the complete text, while in a knowledge graph, the comparison is done against key entities and relationships extracted from the text. There are nuances where one approach works better than the other and thus, both approaches are considered to be within the spirit and scope of the present invention and the illustrative embodiments.

Thus, in summary, in some illustrative embodiments, the user's environment 280 includes their computing device 240, for example a cellphone, which has a microphone 242, camera 244 and other user interface sensors 246, and one or more other computing devices 260. The microphone 242, camera 244 and other user interface sensors 246 record data of the interactions between the user and users of the other computing devices within the environment 280, e.g., audio data, video data, and the like, where this recorded data may be uploaded to cloud computing system 270. The user computing device 240 includes the AI-based privacy preserving tool or PPT 200 which uses the information captured from the recording devices 242-246 to correlate against incoming unsolicited messages.

With regard to the PPT 200, the user interface 210 is used to input the user's privacy preferences 212. The user interface 210 also serves as a way for the user to receive notifications from the notification engine 230. For data collection devices that collect and enable user privacy preferences, the PPT 200 uses the user preferences communication engine 222 to communicate those preferences. The data collection devices, e.g., one or more of user computing device 240 and computing devices 260, send out a broadcast signal that they are listening/watching interactions occurring within the environment 280. The PPT 200 shares its communication preferences using the communication application interface 220. If the user has selected not to be recorded, the users digital signature 224 is communicated to the recording device, e.g., on user computing device 240 and/or other computing devices 260, to aid those recording devices to filter out data as defined by the user privacy preferences 212. If the recording is allowed, the recording device continues as normal.

For data collection devices that do not collect user preferences, the PPT 200 attempts to determine when the user's information is being collected. Once the user has input their privacy preferences 212 and started the tracking, the user activities and interaction tracking engine 214 captures and stores information in the historical correlation data store 228. This information is continuously tracked throughout the time the user is active. This includes things the user says, emails the user reads, user calendar information, and the like. As the user performs these activities or interactions, the PPT 200 uses computer speech-to-text, computer natural language processing, a semantic model, location services, and the like, to extract entities, intents, and locations (via the location services interface 216) to form “themes”, where a “theme” comprises one or more of these types of information that together describe an activity or interaction, e.g., a combination of one or more entities, one or more intents, and a location. These user “themes” are stored in the historical correlation store 228. Similarly, the PPT 200 also tracks unwanted or unsolicited communications or solicitations the user receives, such as via advertisements on webpages, emails, pop-up messages, etc. and using a similar processing of the content of these messages via computer natural language processing, the semantic model, and the like, to identify entities, intents, and locations in the historical correlation store 228 as “message themes”.

The PPT 200 then correlates the user themes with the message themes using the AI privacy risk prediction engine 226. The AI privacy risk prediction engine 226 scores the distance between the user themes and the message themes, and uses that distance score to determine if a correlation exists. The AI privacy risk prediction engine 226 determines the distance from the historical correlation which can be implemented using either a vector data structure or a graph database. If the distance is below a threshold, then the correspondence between the user theme and the message theme may be marked as a trigger indicating that there is a likely correspondence where the interaction was recorded and shared which caused the corresponding unsolicited or unwanted communication/solicitation. False triggers can be avoided by requiring a minimum number of correlation triggers before a notification is sent. User and/or message themes can be made to expire after a period of time to avoid incorrect correlations with historical events.

Once sufficient triggers for a specific set of correlations are identified, the user is notified via the notification engine 230 of these correlations indicating that recording of user interactions/activities may have been shared to cause unsolicited/unwanted communications to be received by the user. The PPT 200 may also alert, via the notification engine 230, the user when the user enters a location (identified via location services interface 216) known to have previously been involved in user information being gathered and shared such that unsolicited or unwanted communications were received thereafter. The PPT 200 can also share summaries of the user's interactions, and the correlations with unsolicited communications, during a configurable period of time.

To avoid user information from the PPT 200 being compromised, the PPT 200 can run locally on the user's device or within a user's trusted network. Additionally, data to and from the PPT 200 can be encrypted when stored or transmitted. In some illustrative embodiments, federated machine learning can be used for training AI models running on the user's computing device 240, e.g., AI models in user activities and interaction tracking engine 214, AI privacy risk prediction engine 226, and the like, for extracting and processing relevant information from the collected data in order to support the execution of the PPT 200 and its components.

Thus, the illustrative embodiments provide an improved computing tool and improved computing tool operations/functionality that operates to preserve a user's privacy with regard to recordings of their audio, images, and interactions with computing devices in accordance with user preferences. The illustrative embodiments provide capabilities to determine whether a recording of the user is likely being performed and to remove aspects of the user from recordings. The illustrative embodiments provide capabilities for one computing device to inform other computing devices of the user's preferences with regard to recordings and cause these other computing devices to abide by such preferences when performing recordings. The illustrative embodiments provide capabilities to correlate subsequent unwanted communications or solicitations with prior activities, interactions, and the like, to thereby determine a likelihood that these prior activities, interactions, and the like were recorded and using this information to provide notifications and alerts to users of the potential of recording occurring again in the future.

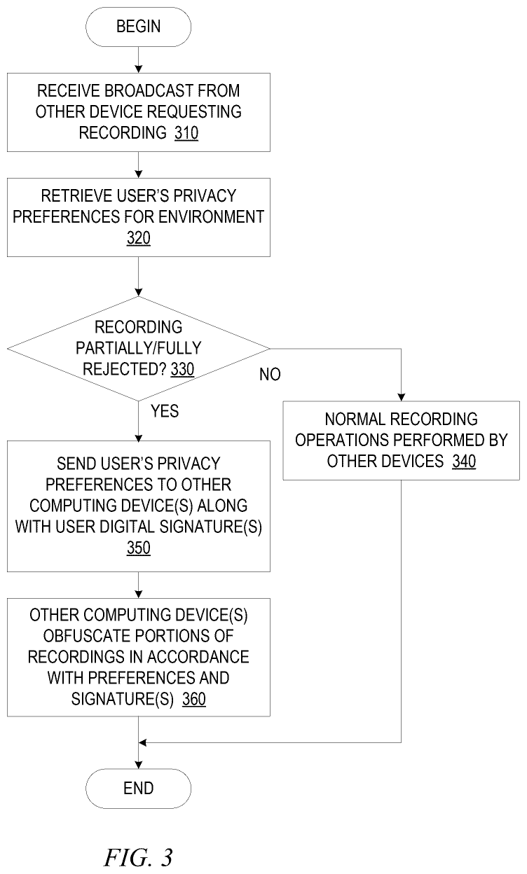

FIGS. 3-5 present flowcharts outlining example operations of elements of the present invention with regard to one or more illustrative embodiments. It should be appreciated that the operations outlined in FIGS. 3-5 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 3-5, and may, in some cases, make use of the results generated as a consequence of the operations set forth in FIGS. 3-5, the operations in FIGS. 3-5 themselves are specifically performed by the improved computing tool in an automated manner.

FIG. 3 is a flowchart outlining an example operation for active detection of recording and communicating user preferences in accepting or rejecting the recording in accordance with one illustrative embodiment. As shown in FIG. 3, the operation starts by receiving, from the recording devices within an environment, broadcasts of their presence and the fact that they are wanting to record activities/interactions within the environment (step 310). The user's computing device retrieves the user's privacy preferences for the environment (step 320) and determines if the user's privacy preferences allow or at least partially reject the recordings (step 330). If the preferences allow the recording, normal recording operation by the other devices is permitted to continue (step 340). If the preferences do not allow at least part of the recordings, then the user's privacy preferences are sent to the other computing devices along with a user digital signature to be used to obfuscate or remove aspects of recordings corresponding to the user (step 350). The other computing devices obfuscate or remove these aspects from the recordings using the user's digital signature (step 360). The operation then terminates.

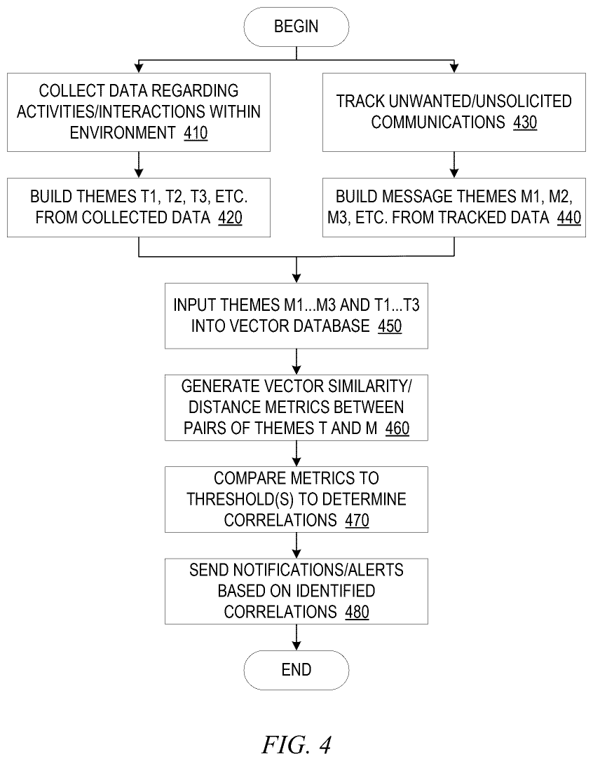

FIG. 4 is a flowchart outlining an example operation for indirect detection of recording in environments in accordance with one illustrative embodiment. As shown in FIG. 4, the operation comprises the collection of data regarding activities/interactions within an environment (step 410) with subsequent building of themes T1, T2, T3, etc. from the collected data (step 420). Similarly, unwanted/unsolicited communications are tracked (step 430) and processed to extract message themes M1, M2, M3, etc. (step 440). The themes T1, T2, T3, etc. and M1, M2, M3, etc. are input to a vector database (step 450). A vector similarity or distance metric is generated between the themes T1, T2, T3, etc., and the message themes M1, M2, M3, etc. (step 460). The vector similarity or distance is compared to one or more thresholds to determine if there is a correlation between pairings of theme T and M (step 470). Based on the determination of whether there is a correlation or not, a notification or alert is generated and output to the user via their computing device (step 480). The operation then terminates.

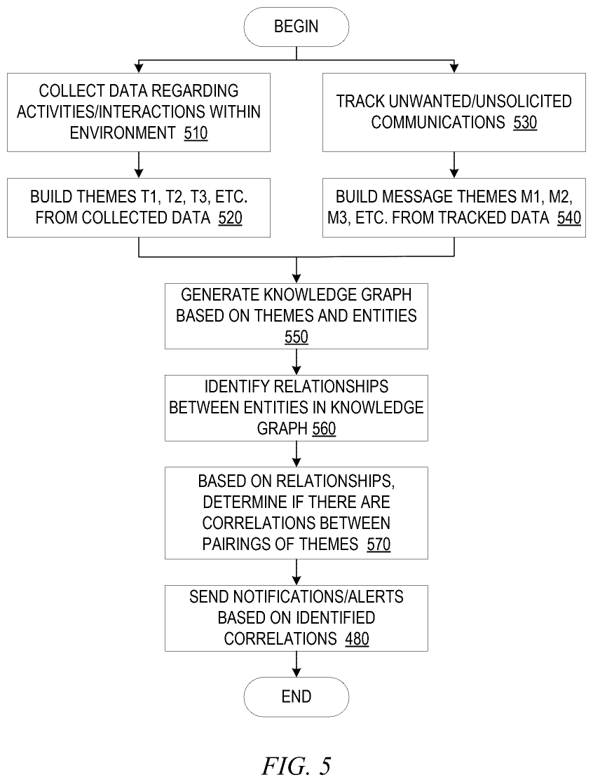

FIG. 5 is a flowchart outlining an example operation for indirect detection of recording in environments in accordance with another illustrative embodiment. As shown in FIG. 5, the operation comprises the collection of data regarding activities/interactions within an environment (step 510) with subsequent building of themes T1, T2, T3, etc. from the collected data (step 520). Similarly, unwanted/unsolicited communications are tracked (step 530) and processed to extract message themes M1, M2, M3, etc. (step 540). The themes T1, T2, T3, etc. and M1, M2, M3, etc. are used to generate a knowledge graph (step 550). Relationships between entities in the knowledge graph are identified (step 560). Based on the identified relationships between entities, it is determined if there is a correlation between pairings of theme T and M (step 570). Based on the determination of whether there is a correlation or not, a notification or alert is generated and output to the user via their computing device (step 580). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
listening, by a user computing device, for a broadcast signal of a data collection device within a monitored environment;
determining, by the user computing device, in response to receiving the broadcast signal, whether to allow or reject data collection by the data collection device;
in response to the user computing device determining to reject data collection by the data collection device, sending, by the user computing device, a user signature of a user of the user computing device to the data collection device; and
instructing, by the user computing device, the data collection device to not record data corresponding to the user signature when recording data associated with activities or interactions within the monitored environment.

2. The method of claim 1, further comprising:
tracking user activities and interactions of the user for a first period of time and storing data corresponding to the user activities and interactions in a historical database;
executing computer logic based on a semantic model to extract entities and intents from the data, stored in the historical database, corresponding to the tracked user activities and interactions; and
building one or more user themes based on the extracted entities and intents.

3. The method of claim 2, further comprising:
tracking received unsolicited communications for a second period of time and storing data corresponding to characteristics of the unsolicited communications; and
executing computer logic based on a semantic model to extract one or more message themes from the data corresponding to the characteristics of the unsolicited communications.

4. The method of claim 3, further comprising:
using a vector database to correlate the one or more user themes with the one or more message themes;
determining one or more triggers based on the correlations from the vector database; and
outputting an alert to the user, via the user computing device, in response to a trigger, of the one or more triggers, being active, wherein the alert specifies that user activity or interaction was recorded and caused a subsequent unsolicited communication.

5. The method of claim 3, further comprising:
using a knowledge graph to correlate the one or more user themes with one or more marketing themes;
determining one or more relationships based on the correlations from the knowledge graph; and
outputting an alert to the user, via the user computing device, in response to a relationship, of the one or more relationships, being true, wherein the alert specifies that user activity or interaction was recorded and caused a subsequent unsolicited communication.

6. The method of claim 1, wherein the data collection device filters out data matching the user signature from a recording of activities or interactions within the monitored environment.

7. The method of claim 1, wherein the user signature is one of an image of the user or a voiceprint signature of the user.

8. A computer program product comprising:
one or more computer-readable storage media; and
program instructions stored on the one or more computer-readable storage media to perform operations comprising:
listening, by a user computing device, for a broadcast signal of a data collection device within a monitored environment;
determining, by the user computing device, in response to receiving the broadcast signal, whether to allow or reject data collection by the data collection device;
in response to the user computing device determining to reject data collection by the data collection device, sending, by the user computing device, a user signature of a user of the user computing device to the data collection device; and
instructing, by the user computing device, the data collection device to not record data corresponding to the user signature when recording data associated with activities or interactions within the monitored environment.

9. The computer program product of claim 8, wherein the operations further comprise:
tracking user activities and interactions of the user for a first period of time and storing data corresponding to the user activities and interactions in a historical database;
executing computer logic based on a semantic model to extract entities and intents from the data, stored in the historical database, corresponding to the tracked user activities and interactions; and
building one or more user themes based on the extracted entities and intents.

10. The computer program product of claim 9, wherein the operations further comprise:
tracking received unsolicited communications for a second period of time and storing data corresponding to characteristics of the unsolicited communications; and
executing computer logic based on a semantic model to extract one or more message themes from the data corresponding to the characteristics of the unsolicited communications.

11. The computer program product of claim 10, wherein the operations further comprise:
using a vector database to correlate the one or more user themes with the one or more message themes;
determining one or more triggers based on the correlations from the vector database; and
outputting an alert to the user, via the user computing device, in response to a trigger, of the one or more triggers, being active, wherein the alert specifies that user activity or interaction was recorded and caused a subsequent unsolicited communication.

12. The computer program product of claim 10, wherein the operations further comprise:
using a knowledge graph to correlate the one or more user themes with one or more marketing themes;
determining one or more relationships based on the correlations from the knowledge graph; and
outputting an alert to the user, via the user computing device, in response to a relationship, of the one or more relationships, being true, wherein the alert specifies that user activity or interaction was recorded and caused a subsequent unsolicited communication.

13. The computer program product of claim 8, wherein the data collection device filters out data matching the user signature from a recording of activities or interactions within the monitored environment.

14. The computer program product of claim 8, wherein the user signature is one of an image of the user or a voiceprint signature of the user.

15. A computer system comprising:
a processor set;
one or more computer-readable storage media; and
program instructions stored on the one or more computer-readable storage media to cause the processor set to perform operations comprising:
listening, by a user computing device, for a broadcast signal of a data collection device within a monitored environment;
determining, by the user computing device, in response to receiving the broadcast signal, whether to allow or reject data collection by the data collection device;
in response to the user computing device determining to reject data collection by the data collection device, sending, by the user computing device, a user signature of a user of the user computing device to the data collection device; and
instructing, by the user computing device, the data collection device to not record data corresponding to the user signature when recording data associated with activities or interactions within the monitored environment.

16. The computer system of claim 15, wherein the operations further comprise:
tracking user activities and interactions of the user for a first period of time and storing data corresponding to the user activities and interactions in a historical database;
executing computer logic based on a semantic model to extract entities and intents from the data, stored in the historical database, corresponding to the tracked user activities and interactions; and
building one or more user themes based on the extracted entities and intents.

17. The computer system of claim 16, wherein the operations further comprise:
tracking received unsolicited communications for a second period of time and storing data corresponding to characteristics of the unsolicited communications; and
executing computer logic based on a semantic model to extract one or more message themes from the data corresponding to the characteristics of the unsolicited communications.

18. The computer system of claim 17, wherein the operations further comprise:
using a vector database to correlate the one or more user themes with the one or more message themes;
determining one or more triggers based on the correlations from the vector database; and
outputting an alert to the user, via the user computing device, in response to a trigger, of the one or more triggers, being active, wherein the alert specifies that user activity or interaction was recorded and caused a subsequent unsolicited communication.

19. The computer system of claim 17, wherein the operations further comprise:
using a knowledge graph to correlate the one or more user themes with one or more marketing themes;
determining one or more relationships based on the correlations from the knowledge graph; and
outputting an alert to the user, via the user computing device, in response to a relationship, of the one or more relationships, being true, wherein the alert specifies that user activity or interaction was recorded and caused a subsequent unsolicited communication.

20. The computer system of claim 15, wherein the user signature is one of an image of the user or a voiceprint signature of the user.
